(19) United States
(12) Patent Application Publication
(10) Pub. No.: US 2025/0391112 A1
(43) Pub. Date: Dec. 25, 2025

(54) MESH ESTIMATION USING HEAD MOUNTED DISPLAY IMAGES

(71) Applicant: QUALCOMM Incorporated, San Diego, CA (US)

(72) Inventors: Mohit LAMBA, New Delhi (IN); Anupama S, Chennai (IN); Rahul MITRA, Kolkata (IN); Avani RAO, Bangalore (IN); T M Feroz ALI, Thrissur (IN); Chiranjib CHOUDHURI, Bangalore (IN); Ajit Deepak GUPTE, Bangalore (IN); Tejas Govind INDANI, Latur (IN)

(21) Appl. No.: 18/749,371

(22) Filed: Jun. 20, 2024

(51) Int. Cl. G06T 17/20; G06T 5/20; G06T 5/70; H04N 23/21

(52) U.S. Cl. CPC G06T 17/20; G06T 5/20; G06T 5/70; H04N 23/21; G06T 2207/20081

(57) ABSTRACT

Systems and techniques are described for performing mesh estimation using head mounted display (HMD) images. For example, a computing device can obtain a set of near infrared (NIR) images of a first face from a set of cameras on a head mounted device (HMD) worn on the first face. The computing device can predict, using a machine learning (ML) model, a set of parameters. The set of parameters describe a mesh model of the first face based on the set of NIR images. The computing device can generate, using the ML model, the mesh model of the first face based on the predicted set of parameters.

### FIELD

This application is related to content for extended reality (XR) systems. For example, aspects of the application relate to systems and techniques for mesh estimation using head mounted display (HMD) images.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto images of a real-world environment, which can be viewed by a user through an XR device (e.g., a head-mounted display (HMD), extended reality glasses, or other device). For example, an XR device can display an environment to a user. The environment is at least partially different from the real-world environment in which the user is in. The user can generally change their view of the environment interactively, for example by tilting or moving the XR device (e.g., the HMD or other device).

An XR system can include a “see-through” display that allows the user to see their real-world environment based on light from the real-world environment passing through the display. In some cases, an XR system can include a “pass-through” display that allows the user to see their real-world environment, or a virtual environment based on their real-world environment, based on a view of the environment being captured by one or more cameras and displayed on the display. “See-through” or “pass-through” XR systems can be worn by users while the users are engaged in activities in their real-world environment.

In some cases, XR systems may be used to enhance experiences, such as for telepresence, gaming, metaverse, etc. Such technologies may allow a person to perform actions and/or have experiences, such as a collaborative and/or interactive experience with other persons, at a remote and/or virtual locations. In some cases, users may be represented in a virtual space as an animated avatar which may mimic movements and/or expressions of their representative user. A particular user may view the remote/virtual locations from a perspective of the avatar, for example, via an XR display device, such as a head mounted display (HMD) or mobile device. A precise reconstruction of a user's face for the avatar may allow for a more seamless, high quality, experience. In some cases, techniques for mesh estimation using HMD images may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for generating one or more mesh models is provided. The apparatus includes at least one memory and at least one processor coupled to the at least one memory and configured to: obtain a set of near infrared (NIR) images of a first face from a set of cameras on a head mounted device (HMD) worn on the first face; predict, using a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and generate, using the ML model, the mesh model of the first face based on the predicted set of parameters.

In some aspects, a method for generating one or more mesh models is provided. The method includes: obtaining a set of near infrared (NIR) images of a first face from a set of cameras on a head mounted device (HMD) worn on the first face; predicting, by a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and generating, by the ML model, the mesh model of the first face based on the predicted set of parameters.

In some aspects, a non-transitory computer-readable medium is provided having stored thereon instructions that, when executed by at least one processor, cause the at least one processor to: obtain a set of near infrared (NIR) images of a first face from a set of cameras on a head mounted device (HMD) worn on the first face; predict, using a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and generate, using the ML model, the mesh model of the first face based on the predicted set of parameters.

In some aspects, an apparatus for generating one or more mesh models is provided. The apparatus includes: means for obtaining a set of near infrared (NIR) images of a first face from a set of cameras on a head mounted device (HMD) worn on the first face; means for predicting, by a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and means for generating, by the ML model, the mesh model of the first face based on the predicted set of parameters.

In some aspects, an apparatus for generating a mesh model is provided. The apparatus includes at least one memory and at least one processor coupled to the at least one memory and configured to: predict a set of parameters, the set of parameters describing an inner face mesh for a face; generate the inner face mesh based on the predicted set of parameters; join the inner face mesh with an outer face mesh to generate a mesh model of a face; and output the mesh model of the face.

In some aspects, a method for generating a mesh model is provided. The method includes: predicting a set of parameters, the set of parameters describing an inner face mesh for a face; generating the inner face mesh based on the predicted set of parameters; joining the inner face mesh with an outer face mesh to generate a mesh model of a face; and outputting the mesh model of the face.

In some aspects, a non-transitory computer-readable medium is provided having stored thereon instructions that, when executed by at least one processor, cause the at least one processor to: predict a set of parameters, the set of parameters describing an inner face mesh for a face; generate the inner face mesh based on the predicted set of parameters; join the inner face mesh with an outer face mesh to generate a mesh model of a face; and output the mesh model of the face.

In some aspects, an apparatus for generating one or more mesh models is provided. The apparatus includes: means for predicting a set of parameters, the set of parameters describing an inner face mesh for a face; means for generating the inner face mesh based on the predicted set of parameters; joining the inner face mesh with an outer face mesh to generate a mesh model of a face; and means for outputting the mesh model of the face.

In some aspects, the apparatus can include or be part of an extended reality (XR) device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIGS. 3A-3D and FIG. 4 are diagrams illustrating examples of neural networks, in accordance with some examples.

FIG. 5A is a perspective diagram illustrating a head-mounted display (HMD), in accordance with some examples.

FIG. 5B is a perspective diagram illustrating the HMD of FIG. 5A, in accordance with some examples.

FIG. 6 illustrates a technique for generating synthetic HMD images for training a ML model to perform mesh estimation using HMD images, in accordance with aspects of the present disclosure.

FIG. 7 illustrates a technique for training a ML model to perform mesh estimation using HMD images, in accordance with aspects of the present disclosure.

FIG. 8 illustrates ML techniques for mesh estimation using HMD images, in accordance with aspects of the present disclosure.

FIG. 9 illustrates a parameterized inner mesh model in accordance with aspects of the present disclosure.

FIG. 10 is a diagram illustrating a technique for pre-processing 3DMM meshes 1000, in accordance with aspects of the present disclosure.

FIG. 11 is a block diagram illustrating a technique for training a ML model for predicting parameters for describing an inner face region of a face based on images from an HMD, in accordance with aspects of the present disclosure.

FIG. 12 is a flow diagram illustrating a process for generating a mesh model, in accordance with aspects of the present disclosure.

FIG. 13 is a flow diagram illustrating a process for training an ML model, in accordance with aspects of the present disclosure.

FIG. 14 is a flow diagram illustrating a process for generating a mesh model, in accordance with aspects of the present disclosure.

FIG. 15 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, a user may be represented in a virtual environment by an avatar for the user. To enhance immersion into the virtual environment, the avatar may be configured with a face that may reflect expressions of the user. In some cases, the avatar may be generated based on a mesh model created based on images of the user. Traditionally, the images of the user used to generate the mesh model have an unobstructed, frontal, and color (e.g., RGB) view of the face of the user. However, an XR system may include a head mounted display which can obstruct views of faces and obtaining a front view of face may be difficult absent a companion device or other camera separate from an HMD. However, a separate companion device can increase costs and make it more difficult to use the HMD. Further HMD may use near infrared (NIR) cameras (e.g., within the HMD device), to capture images of a portion of the face obscured by the HMD device. These NIR images can differ from color images and may not be compatible with models trained on RGB images. In some cases, techniques for training a ML model to perform mesh estimation using HMD images may be useful.

Systems, apparatuses, electronic devices, methods (also referred to as processes), and computer-readable media (collectively referred to herein as “systems and techniques”) are described herein for training an ML model for to perform mesh estimation using HMD images. For example, images of a subject (e.g., user) may be captured and used to generate a ground truth mesh for training. A mesh model of an HMD may be fitted to the ground truth mesh. Synthetic HMD user images of a textured ground truth mesh may be generated. In some cases, the synthetic HMD user images may be taken (e.g., captured) from a location corresponding to where inward facing cameras of an HMD would be located. The synthetic HMD user images may be converted to near infrared (NIR) to generate synthetic NIR HMD user images. The synthetic NIR HMD user images may be used to train the ML model to generate a predicted mesh model. Losses may be determined based on the predicted mesh model and the ground truth mesh. In some cases, augmentations in the color, geometric and discriminator space may be applied to better convert images from a color domain to an NIR domain. In some cases, details of the mesh model may be further enhanced by allowing the ML model to predict an inner face portion of the face based on HMD images. The inner face portion may be fused with a static outer face portion.

Various aspects of the application will be described with respect to the figures.

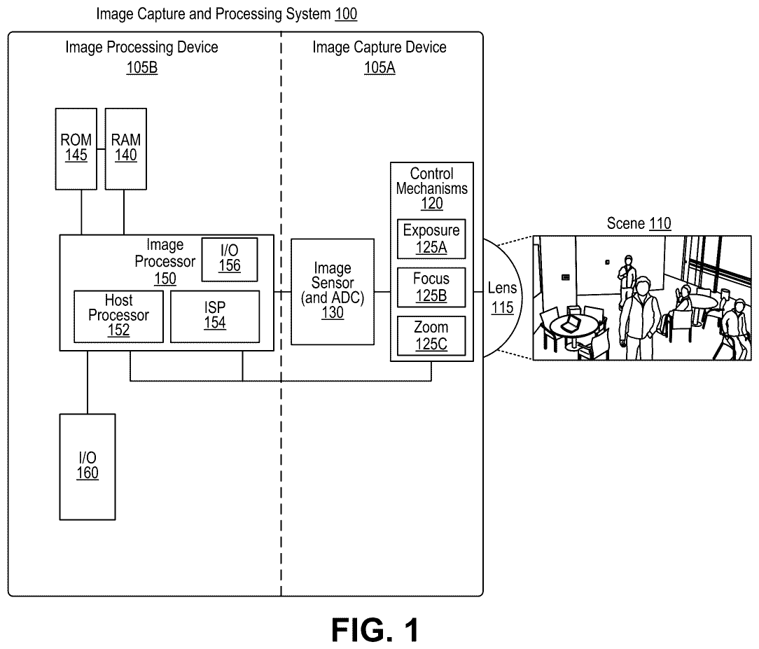

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

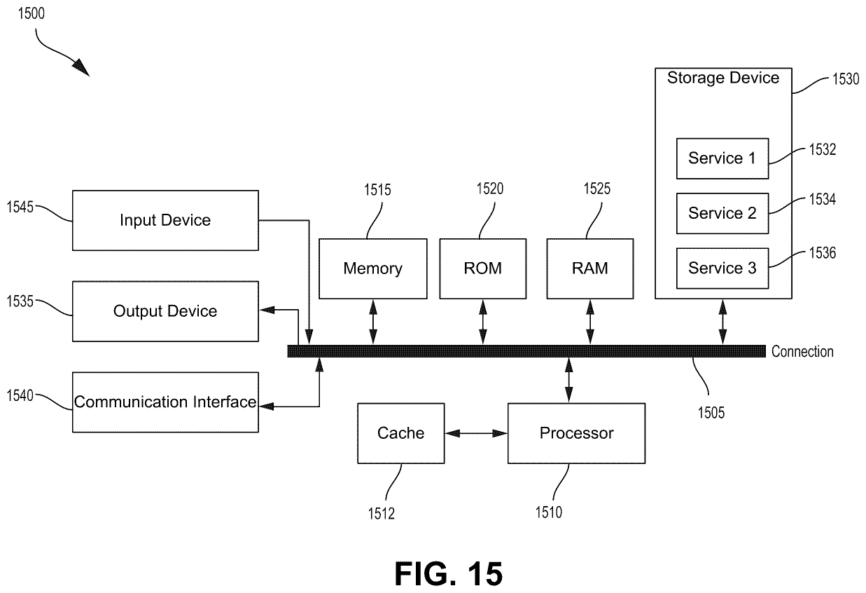

The image processor 150 may include one or more processors, such as one or more image signal processors (ISPs) (including ISP 154), one or more host processors (including host processor 152), and/or one or more of any other type of processor 1510 discussed with respect to the computing system 1500 of FIG. 15. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1125, read-only memory (ROM) 145/1120, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

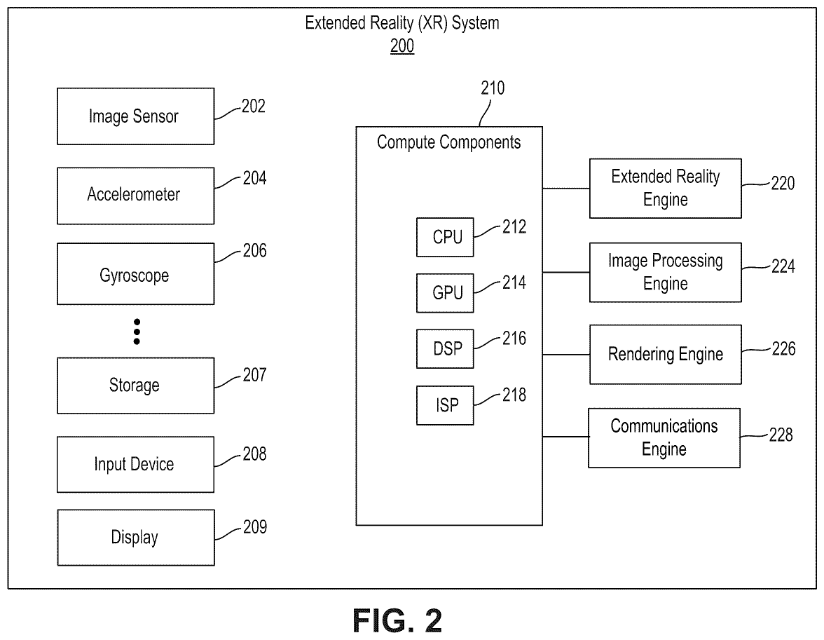

In some examples, the extended reality (XR) system 200 of FIG. 2 can include the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1145 discussed herein, or any combination thereof. In some cases, the image sensor 202 can capture images that can be processed for interpreting gesture commands.

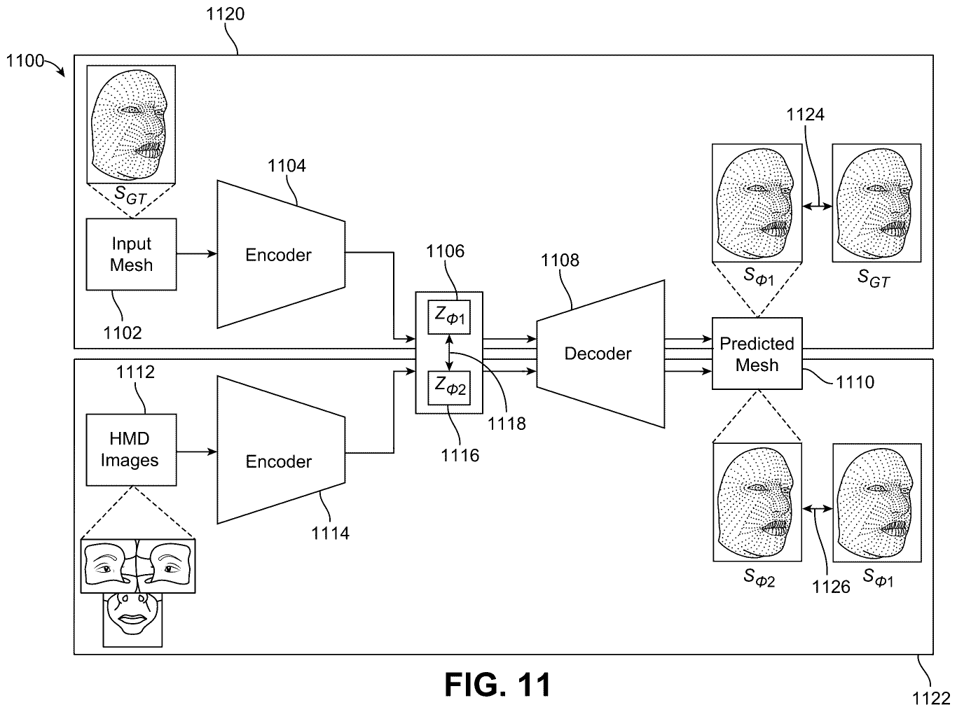

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1140 of FIG. 11.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 210 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

A neural network is an example of a machine learning system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

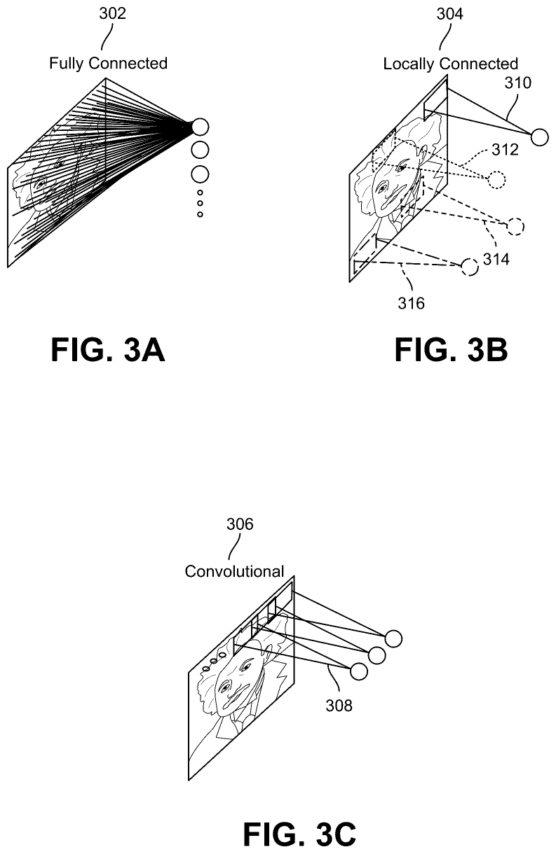

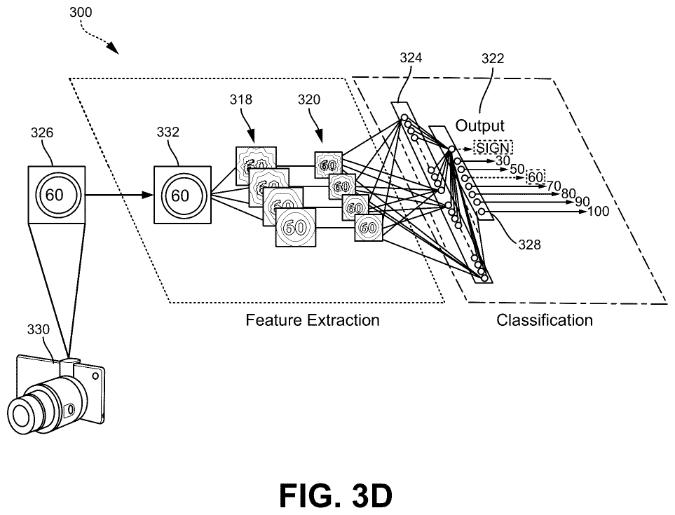

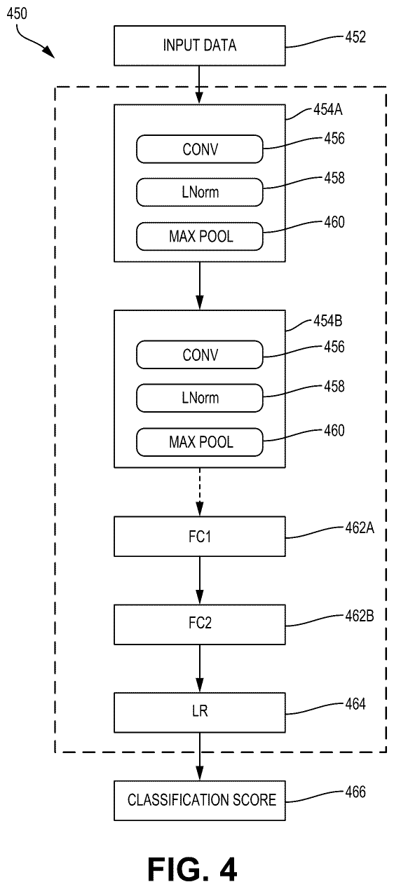

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330.

The DCN 300 may be trained with supervised learning. During training, the DCN 300 may be presented with an image, such as the image 326 of a speed limit sign, and a forward pass may then be computed to produce an output 322. The DCN 300 may include a feature extraction section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory clonsumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a CPU 212 or GPU 214 of the compute components 210 to achieve high performance and low power consumption. In alternative aspects, the parallel filter banks may be loaded on the DSP 216 or an ISP 218 of an the compute components 210. In addition, the deep convolutional network 450 may access other processing blocks that may be present on the compute components 210, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

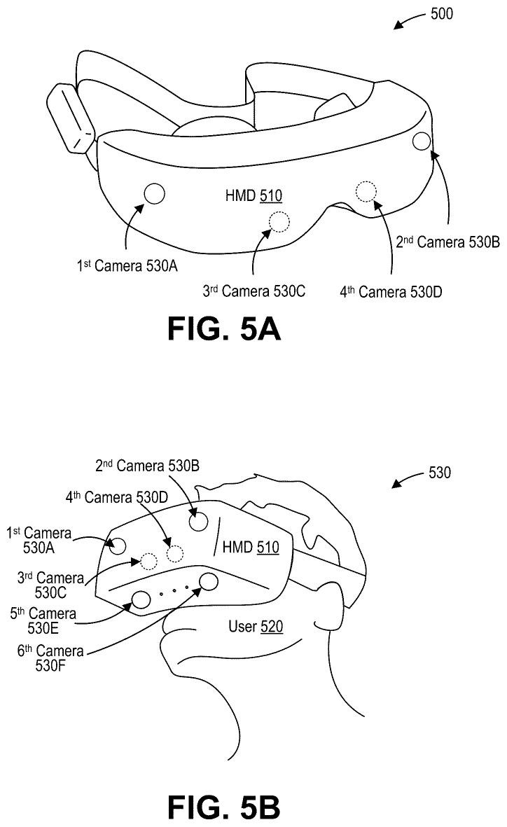

FIG. 5A is a perspective diagram 500 illustrating a head-mounted display (HMD) 510, in accordance with some examples. The HMD 510 may be, for example, an augmented reality (AR) headset, a virtual reality (VR) headset, a mixed reality (MR) headset, an extended reality (XR) headset, or some combination thereof. The HMD 510 may be an example of an XR system 200, a SLAM system, or a combination thereof. The HMD 510 includes a first camera 530A and a second camera 530B along a front portion of the HMD 510 which are outward facing (e.g., to capture images of the environment around the HMD 510). In some examples, the HMD 510 may only have a single outward facing camera. In some examples, the HMD 510 may include one or more additional outward facing cameras in addition to the first camera 530A and the second camera 530B. The HMD 510 includes a third camera 530C and fourth camera 530D, which are inward facing to capture images of portions of the face of a user of the HMD 510 that may be covered by the HMD 510. In some examples, the HMD 510 may include one or more additional sensors in addition to the cameras.

FIG. 5B is a perspective diagram 530 illustrating the head-mounted display (HMD) 510 of FIG. 5A being worn by a user 520, in accordance with some examples. The user 520 wears the HMD 510 on the user 520's head over the user 520's eyes. The HMD 510 can capture images of the environment with the first camera 530A and the second camera 530B. In some examples, the HMD 510 displays one or more display images toward the user 520's eyes that are based on the images captured by the first camera 530A and the second camera 530B. The display images may provide a stereoscopic view of the environment, in some cases with information overlaid and/or with other modifications. For example, the HMD 510 can display a first display image to the user 520's right eye, the first display image based on an image captured by the first camera 530A. The HMD 510 can display a second display image to the user 520's left eye, the second display image based on an image captured by the second camera 530B. For instance, the HMD 510 may provide overlaid information in the display images overlaid over the images captured by the first camera 530A and the second camera 530B.

The HMD 510 can also capture images of portions of the face of the user that may be covered by the HMD 510 using the third camera 530C and fourth 530D. The HMD 510 can also capture images of portions of the face of the user below the HMD 510 device (e.g., a region of the face around the lips, lower cheeks, etc.) using a fifth camera 530E and a sixth camera 530F. In some cases, a single camera may be used in place of the fifth camera 530E and a sixth camera 530F.

The HMD 510 may include no wheels, propellers or other conveyance of its own. Instead, the HMD 510 relies on the movements of the user 520 to move the HMD 510 about the environment. In some cases, for instance where the HMD 510 is a VR headset, the environment may be entirely or partially virtual. If the environment is at least partially virtual, then movement through the virtual environment may be virtual as well. For instance, movement through the virtual environment can be controlled by an input device 208. The movement actuator may include any such input device 208. Movement through the virtual environment may not require wheels, propellers, legs, or any other form of conveyance. Even if an environment is virtual, SLAM techniques may still be valuable, as the virtual environment can be unmapped and/or may have been generated by a device other than the HMD 510, such as a remote server or console associated with a video game or video game platform.

In some cases, a virtual representation (e.g., avatar) of a user in a virtual environment may be generated based on a mesh. In some cases, one or more meshes (e.g., including a plurality of vertices, edges, and/or faces in three-dimensional space) with corresponding materials may be used to represent an avatar. The materials may include one or more textures such as a normal texture, a diffuse or albedo texture, a specular reflection texture, any combination thereof, and/or other materials or textures. In some cases, a parametric 3D morphological model (3DMM) may be generated based on images of a user. A parametric 3DMM may be a mesh model (e.g., of a face) that has a predefined topology that may be deformed based on vector values (e.g., parameters). Traditionally, the images of the user used to generate the 3DMM have an unobstructed, frontal, and color (e.g., RGB) view of the face of the user. However, an HMD can obstruct user faces and obtaining a front view of face may be difficult absent a companion device or other camera separate from an HMD device, which can increase costs and make it more difficult to use the HMD device. Further HMD devices may use near infrared (NIR) cameras (e.g., within the HMD device), to capture images of a portion of the face obscured by the HMD device. These NIR images can differ from color images and may not be compatible with models trained on RGB images. In some cases, techniques for training a ML model to perform mesh estimation using HMD images may be useful.

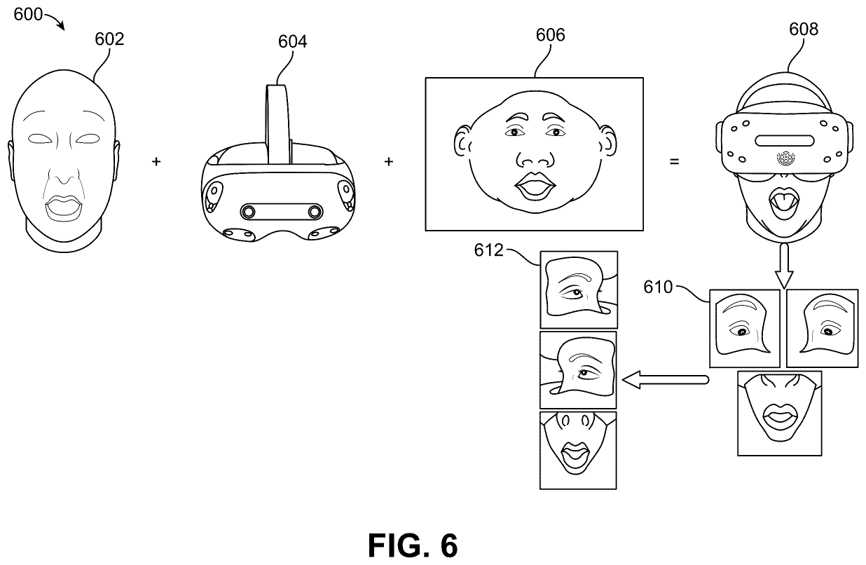

FIG. 6 illustrates a technique for generating synthetic HMD images 600 for training a ML model to perform mesh estimation using HMD images, in accordance with aspects of the present disclosure. In FIG. 6, a ground truth mesh 602 may be obtained for generating synthetic HMD images. In some cases, an RGB texture 606 may be added to the ground truth mesh 602. The ground truth mesh 602 may also be fitted with an HMD mesh 604 to obtain a ground truth textured mesh fitted with the HMD 608. In some cases, fitting the ground truth mesh 602 with the HMD mesh 604 may be based on vertices of the ground truth mesh 602 where the HMD would contact. For example, vertices of the ground truth mesh 602 corresponding to the bridge of the nose, temple, any combination thereof, and the like may be identified for use to fit the HMD mesh 604. In some cases, these identified vertices of the ground truth mesh 602 may be merged with vertices of the HMD mesh 604. The ground truth mesh 602 may be generated using any technique for generating a 3DMM mesh. For example, multiple subjects expressing a variety of expressions may be imaged from multiple angles using cameras with known camera properties and these images may be used together to create the ground truth mesh 602. The RGB texture 606 may also be generated using any technique. For example, the images may also be used to generate the RGB texture 606 associated with the ground truth mesh 602. The HMD mesh 604 may be also obtained in any technique. For example, the HMD mesh 604 may be generated based on, for example, models of the HMD, such as CAD models, created by a manufacturer of the HMD.

After the HMD mesh 604 and ground truth mesh 602 have been obtained, the HMD mesh 604 may be fitted to the ground truth mesh 602 to generate the ground truth textured mesh fitted with the HMD 608. In some cases, fitting the HMD mesh 604 may be performed such that the following conditions are fulfilled:

$${G}_{e}^{x} = {H}_{s}^{x} and {G}_{e}^{y} = {H}_{s}^{y} and {H}_{s}^{z} - {G}_{e}^{z} = ER ,$$

where H denotes the HMD mesh and G denotes the GT mesh, where

$${G}_{i}^{x}$$

denotes the x coordinate of vertex i in GT mesh G. In some cases, the HMD may move around during use, for example due to different. To account for this, the movement of the HMD may be accounted as follows:

$$\vert {G}_{e}^{x} - {H}_{s}^{x} \vert < α , \vert {G}_{e}^{y} - {H}_{s}^{y} \vert < β , and {γ}_{1} < {G}_{e}^{z} - {H}_{s}^{z} < {γ}_{2} .$$

Based on the ground truth textured mesh fitted with the HMD 608, synthetic HMD user views 610 may be generated. For example, 3D rendering techniques may be used to render the synthetic HMD user views 610 of the textured mesh model from an expected placement of the inward facing cameras (e.g., third camera 530C, fourth camera 530D, fifth camera 530E, sixth camera 530F of FIGS. 5A and 5B) of the HMD. Examples of 3D rendering techniques may include Blender, PyTorch3D, etc. The synthetic HMD user views 610 may be generated based on known locations (e.g., placements) and orientations of the inward facing cameras of the HMD device. Lighting information may be based on location/orientation of light sources on the HMD (e.g., IR illuminators on the HMD). In some cases, such as if placement and/or orientation of the inward facing (e.g., facing the user of the HMD) cameras have not yet been determined, the placement and/or orientation of the inward facing cameras may be determined to optimize views of the textured mesh model (e.g., face of a user).

The rendered synthetic HMD user views 610 may be rendered in an RGB domain, while actual images captured by inward facing cameras of the HMD may be in an NR domain. In some cases, training on RGB synthetic images for NTR images may not offer good facial expression tracking because of a domain gap between RGB synthetic images and NTR images during inference. In some cases, training on RGB images converted to the NTR domain can be helpful in improving facial expression tracking. In some cases, the synthetic HMD user views 610 may be converted to a NIR domain to obtain synthetic NIR HMD images 612. This conversion may be performed using any technique. For example, a ML model may be used to convert the synthetic HMD user views 610 from the RGB domain to the NTR domain. The ML model may be a generative adversarial network (GaN) which may learn a bidirectional mapping between two domains (RGB and NTR domain) by enforcing cyclic consistency loss between the two domains and an adversarial loss for each of the two domains. An example of such a GaN may be cycleGaN, which may be used to convert the synthetic HMD user views 610 from the RGB domain to the NTR domain. CycleGaN learns a bidirectional mapping between two domains (RGB and NIR domains) and this mapping may be learned by enforcing a cyclic consistency loss between the two domains and an adversarial loss for each of the two domains. To preserve semantics during the domain transfer, a pose and expression distributions of both domains may be matched. Pose distribution may be matched by using a same headset pose as the HMD captures for synthetic RGB dataset generation. For matching expression distribution, images with a same expression may be captured in RGB and NTR for training the cycleGaN. An identity loss may also be used to help preserve the expressions during transfer.

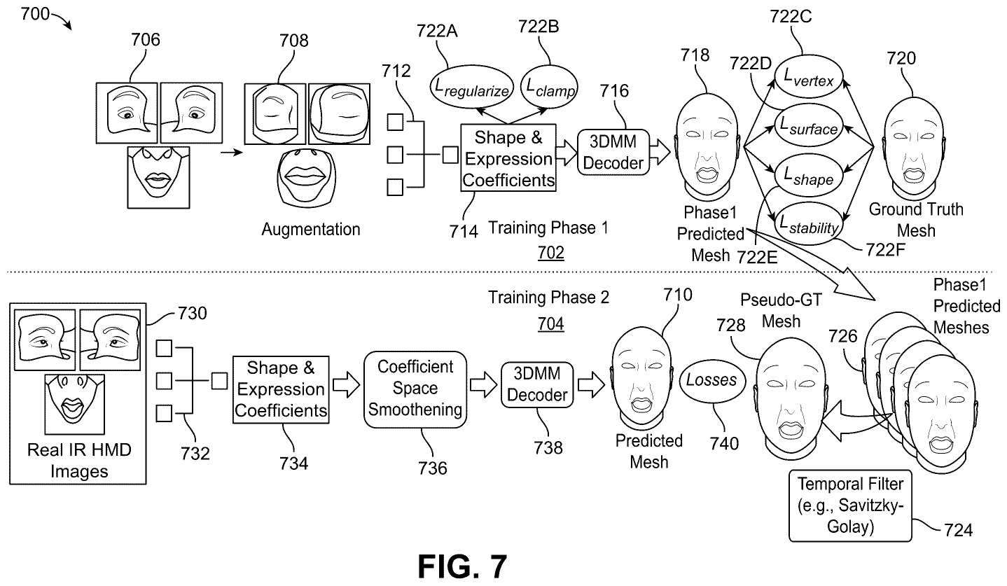

FIG. 7 illustrates a technique for training a ML model 700 to perform mesh estimation using HMD images, in accordance with aspects of the present disclosure. As shown in FIG. 7, the ML model may be trained in a first phase 702 and a second phase 704. As a part of the first phase 702, synthetic NIR HMD images 706 (e.g., synthetic NIR HMD images 612 of FIG. 6) may be augmented to obtain augmented synthetic NIR HMD images 708. The augmentations help make the synthetic NIR HMD images 706 more similar to real-world NIR images. In some cases, synthetic NIR HMD images 706 generated based on RGB images may not fully close the domain gap and may produce sub-optimal results during inference on NIR images. To help improve results, the synthetic NIR HMD images 706 may be augmented 704 (e.g., enhanced). Examples of augmentations that may be applied to synthetic NIR HMD images 706 may include color augmentations, affine transformations, noise injection, target centric augmentations, and the like.

For color augmentations, RGB images and NIR images are captured using different wavelengths of lights and may be subject to color variations as between the images. To help compensate for these color variations, different color augmentations may be applied. In some cases, contrast and/or brightness levels of the RGB images may be varied when generating the NIR images. For example, the contrast and/or brightness of a single RGB image may be varied and used to generate multiple NIR images. In some cases, the contrast and/or brightness may be varied based on the following formula: g(i,j)=α·f(i,j)+β where f is the domain transferred image, g is the augmented images, (i,j) are pixel indices and α, β control the brightness and contrast of the image. As another example, hue and/or saturation may be varied when generating the NIR images. In some cases, the hue may be varied based on:

$$hue = arccos \frac{0.5 ( 2 R - G - B )}{\sqrt{{( R - G )}^{2} - ( R - B ) ( G - B )}} .$$

In some cases, saturation may be varied based on:

$$saturation = \frac{max ( R , G , B ) - min ( R , G , B )}{max ( R , G , B )} .$$

In some cases, synthetic HMD user views (e.g., synthetic HMD user views 610 of FIG. 6) may be generated based on an ideal pinhole projection. However, real cameras may have imperfections which may produce distortion such as barrel distortion, geometric distortions, etc. To help compensate for possible distortion, one or more affine transformations may be applied. In some cases, one or more affine transformations may be applied as:

$$\begin{matrix}{g}_{i , j}^{x} \\ {g}_{i , j}^{y} \\ 1\end{matrix} = H \cdot \begin{matrix}{f}_{i , j}^{x} \\ {f}_{i , j}^{y} \\ 1\end{matrix} ,$$

where g is the augmented image, f is the original image (ideal pinhole projection), i,j are pixel indices, x,y are spatial coordinates of a pixel, and H is an affine matrix. The affine matrix may be modeled based on the affine transformation(s) to be applied.

In some cases, one or more ML models may be used to convert the synthetic RGB HMD images to synthetic NIR HMD images 708. For target centric augmentations, multiple discriminators (e.g., checks) may be incorporated these ML models to allow for a more accurate and robust conversion to help minimize differences between the synthetic NIR HMD images 708 and real NIR HMD images.

In some cases, captured images in a real-world environment may have noise (e.g., light specularities) that may not be present in images captured in lab conditions. This light noise may cause a ML model to output erroneous predictions when such noise occurs. In some cases, noise injection may be used to help train the ML model to compensate for noise. Noise injection may be performed by normalizing the synthetic HMD user views, such that normalized image g₁ can be expressed as

$${g}_{1} ( i , j ) = \frac{h ( i , j )}{max ( h )} ,$$

where i,j are pixel indices, and h represents a brightness value for the synthetic HMD user view. The Laplacian and/or gaussian noise may be added for a noisy image g₂ as g₂(i,j)=g₁(i,j)+N(0,0.03), where N(·, ·) is a normal distribution with specified mean and variance. The noisy image g₂ may then be clamped, such as to values from zero to 1 as g₃(i,j)=Clamp [g₂(i,j)], where

$$Clamp ( x ) = \{ \begin{matrix}0 , & x < 0 \\ 1 , & x \geq 1 \\ x , & otherwise\end{matrix} .$$

In some cases, additional techniques may be applied to help enhance a quality of predicated meshes 718 or 710 may include temporal smoothing, personalized mean meshes, and the like. For example, during inference, it is useful to have a temporally smooth mesh across images to avoid an appearance of jerky movements for an avatar. In some cases, jitter may arise due to issues with the domain gap (e.g., difference between synthetic NIR images and real-work NIR images) and in some cases, jitter in the ground truth models. To compensate for this jitter, it may be useful to apply one or more smoothing filters, such as a Savitzky-Golay filter. In some cases, a two-phase training (e.g., training phase 1 702 and training phase 2 704) may be used to apply smoothing filters.

Returning to the augmented synthetic NIR HMD images 708, the augmented synthetic NTR HMD images 708 may be passed into an encoder 712. The encoder 712 may be trained to generate 3DMM coefficients 714 (e.g., paramaters) for deforming a 3DMM based on input NIR HMD images (e.g., augmented synthetic NIR HMD images 708 during training and NIR HMD images during inference). In some cases, the 3DMM coefficients may be used by a 3DMM decoder 716 to generate a predicted mesh 718 for phase 1. In some cases, the 3DMM coefficients may include a shape coefficient αₛ and an expression coefficient αₑ. The shape coefficient may indicate how a 3DMM may be deformed based on a shape of the face, and the expression coefficient may indicate how a 3DMM may be deformed based on an expression of the face. In some examples, the encoder 712 may be ResNet based model, such as a multi-head ResNet model where ResNet is modified to include multiple heads (three in this example) to accept multiple images (e.g., three augmented synthetic NIR HMD images 708, three NIR from the inward facing cameras of the HMD) in a single pass. The 3DMM coefficients 714 may be passed to the 3DMM decoder 716.

In some cases, the 3DMM decoder 716 may generate the predicted mesh 718 for phase 1 based on the 3DMM coefficients 714, a shape basis Aₛ, an expression basis Aₑ, and a mean face mesh p. The mean mesh p for a face may be an average mesh of a face generated across multiple people. The shape basis Aₛ, may be a fixed (e.g., frozen) vector governing a shape of the face, and the expression basis Aₑ, may be a fixed vector governing the expression of the face. The shape basis Aₛ, an expression basis Aₑ may be modified by the shape coefficient αₛ and the expression coefficient αₑ, such that generation of the predicted mesh 718 for phase 1, P, may be described as P=p̅+αₛAₛ+αₑAₑ.

In some cases, a personalized mesh may be used in place of a mean mesh (e.g., for the 3DMM decoder 716). For example, a specific mesh may be generated per user, such as during a registration or initialization procedure, that may be used for generating the predicted mesh 718 or 710. In some cases, a person specific 3DMM mesh, p_{ID specific}, may be used to better capture facial detail that may not appear on an average mesh of a face, such that P=\sqrt{p_{ID specific}}+αₛAₛ+αₑAₑ.

The predicted mesh 718 for phase 1 may be compared to a ground truth mesh 720 to calculate one or more loss functions for training the encoder 712 and 3DMM decoder 716. For example, the one or more loss functions 722A-722F (collectively loss functions 722) may include a regularization loss 722A (L_{regularize}), a clamping loss 722B (L_{clamp}), a vertex loss 722C (Lᵥₑᵣₜₑₓ), a surface loss 722D (L_{surface}), a shape loss 722E (Lₛₕₐₚₑ), and a stability loss 724F (L_{stability}). In some cases, the regularization loss 722A (L_{regularize}) may be expressed as

$${L}_{regularize} = {‖ {α}_{s : r} ‖}_{2}^{2} + ‖ {α}_{s : r} ‖ ,$$

where s is a shape coefficient and r is an expression coefficient, and used to train the encoder 712. The clamping loss 722B (L_{clamp}) may be expressed as L_{clamp}=f_{LB}(β_{LB}−α_{s:r})+f_{UB,j}(α_{s:r}−β_{UB}) and may also be used to train the encoder 712. The vertex loss 722C (Lᵥₑᵣₜₑₓ) may be expressed as

$${L}_{vertex} = \frac{1}{N} {\sum }_{i = 1}^{N} {w}_{i} {‖ {p}_{i} - \hat{{p}_{ι}} ‖}_{2}^{2}$$

and may be used to train the 3DMM decoder 716. The surface loss 722D (L_{surface}) may be expressed as

$${L}_{surface} = \frac{1}{N} {\sum }_{i = 1}^{N} {{w}_{i} [ {\hat{n}}_{ι} \cdot ( {p}_{i} - \hat{{p}_{ι}} ) ]}^{2}$$

where \hat{n}ᵢ=avg(eᵢⱼ×eᵢₖ)∀j, k∈ [symbol] (i) and may be used to train the 3DMM decoder 716. The shape loss 722E (Lₛₕₐₚₑ) may be expressed as

$${L}_{shape} = {‖ {α}_{s : r}^{j} - {α}_{s : r}^{k} ‖}_{2}^{2} ,$$

where (j, k) belong to a same expression (and thus have a same identifier). The stability loss 724F (L_{stability}) may be expressed as

$${L}_{stability} = {‖ {α}^{s} - {α}^{t} ‖}_{2}^{2} ,$$

where (s, t) represent different camera poses and belong to a same frame.

Based on the loss functions 722, the encoder 712 and 3DMM decoder 716 may be trained with the predicted mesh 718 for phase 1 (e.g., domain transferred images) to predict the predicted mesh 718 for phase 1. During inference, a mesh like the predicted mesh 718 for phase 1 may be predicted by the encoder 712 and 3DMM decoder 716 for each frame. In cases where the encoder 712 and decoder 716 are trained on the augmented synthetic NIR HMD images 708 alone, there may be frame to frame jitter for the predicted mesh 718 for phase 1. To remove this frame to frame jitter, it may be useful to temporally smooth the predicted meshes using a temporal filter while limiting an amount of introduced distortion. An example of such a filter is a Savitzky-Golay filter. The Savitzky-Golay filter is a digital filter that approximates a local set of adjacent points with a low-degree polynomial using least squares method as shown

$${Y}_{j} = {\sum }_{i = \frac{1 - m}{2}}^{\frac{m - 1}{2}} {C}_{i} {y}_{j + i} , \frac{m + 1}{2} \leq j \leq n - \frac{m - 1}{2} ,$$

where the convolution coefficients Cᵢ are predetermined for data points y. For example, if polynomial degree is 2 and neighborhood window is 5, then

$${Y}_{j} = \frac{1}{35} ( - 3 {y}_{j - 2} + 12 {y}_{j - 1} + 17 {y}_{j} + 12 {y}_{j + 1} - 3 {y}_{j + 2} ) .$$

As Savitzky-Golay is a non-casual filter, Savitzky-Golay cannot be applied during inference. Instead, Savitzky-Golay may be applied during training of the encoder 712 and decoder 716 in training phase 2 704 to allow the encoder 712 and decoder 716 to generate (e.g., predict) a smoothened predicted meshes 710. For example, during training phase 1 702, the encoder 712 and decoder 716 may be trained using the augmented synthetic NIR HMD images 708 and tested using real NIR HMD images (not shown) until a good enough expression tracking (e.g., predicted mesh 718 for phase 1 tracks the expression of the input images frame-by-frame for an expression such as a smile) is achieved (e.g., where additional training does not improve results). The Savitzky-Golay filter 724 may then be applied to the phase 1 predicted meshes 726 associated with the expression to obtain pseudo-ground truth meshes 728 for use in training phase 2 704. In some cases, the phase 1 predicted meshes 726 for generating the pseudo-ground truth meshes 728 may be generated based on real NIR HMD images.

In training phase 2 704, real NIR HMD images 730 may be input to encoder 732 to predict 3DMM coefficients 734. In some cases, the real NIR HMD images 730 may correspond to the real NIR HMD images used to generate the pseudo-ground truth meshes 728. The encoder 732 may be the encoder 712 trained during training phase 1 702. The predicted 3DMM coefficients 734 may correspond to 3DMM coefficients 714 from training phase 1 702. A lightweight smoothing 736 may be applied to the 3DMM coefficients 734. The lightweight smoothing 736 may be a casual filter. For example, an exponential moving average of the coefficients may be used to smooth the 3DMM coefficients 734 across frames. For exponential moving average, let nₜ denote the estimated 3DMM coefficients of the current frame and cₜ denote the smoothened coefficients. The exponential moving average of the coefficients may be determined as cₜ=s·nₜ+(1·s)·cₜ₋₁, where s is a hyperparameter which controls the smoothness. In some cases, for faster expressions (e.g., expressions that are relatively temporally quick) a larger s may be used. In some cases, s may be adjustable.

The smoothed 3DMM coefficients 734 may be passed into a 3DMM decoder 738. In some cases, the 3DMM decoder 738 may be the 3DMM decoder 716 trained during training phase 1 702. The 3DMM decoder 738 may generate (e.g., predict) the smoothened predicted meshes 710. The smoothened predicted meshes 710 may be compared to the pseud-ground truth meshes 728 and losses 740 determined. In some cases, loss functions for the losses 740 may be substantially similar to loss functions 722. Based on the losses 740, the encoder 732 and 3DMM decoder 738 may be further trained to generate (e.g., predict) the smoothened predicted meshes 710.

In some cases, in addition to training with synthetic NIR HMD images, additional training with real NIR HMD images may be performed. For example, real NIR images may differ from synthetic NIR HMD images in certain ways, such as how the background may be seen, stray light, shapes and poses on a user-by-user basis. In some cases, a robustness of the encoder (e.g., encoders 712 and 732) and decoder (e.g., 3DMM decoder 716 and 738) may be enhanced with additional training on real NIR images to handle potential variations in the real NIR images. This additional training may include training on multiple captures for same person with different poses, HMD fittings, and/or backgrounds, capturing a diverse set of backgrounds without a user present (e.g., using the HMD cameras) and then augmenting existing training images with these backgrounds, and/or finetuning on real NIR images by forcing the projections of key landmark points of predicted mesh 718 to coincide with landmarks on the real NIR image. In some cases, augmenting exiting training images with different backgrounds may be performed by additionally training a segmentation network or creating background masks during dataset generation.

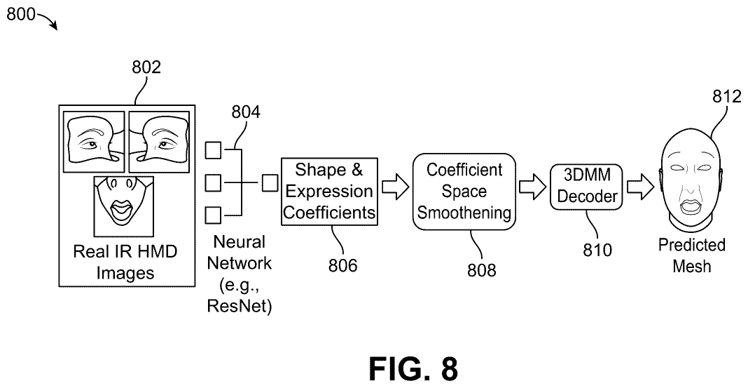

FIG. 8 illustrates ML techniques 800 for mesh estimation using HMD images, in accordance with aspects of the present disclosure. In some cases, the ML techniques 800 may be similar to training phase 2 704 of FIG. 7. For example, real NTR HMD images 802 may be input to ML model 804 to predict 3DMM coefficients 806. The ML model 804 may be trained via training phase 1 702 and training phase 2 704 of FIG. 7. A lightweight smoothing 808 may be applied to the 3DMM coefficients 806. In some cases, the lightweight smoothing 808 applied may correspond to the lightweight smoothing 736 of FIG. 7. The smoothed 3DMM coefficients may be input to a 3DMM decoder 810. The 3DMM decoder 810 may be trained via training phase 1 702 and training phase 2 704 of FIG. 7. The 3DMM decoder 810 may generate (e.g., predict) the predicted mesh 812.

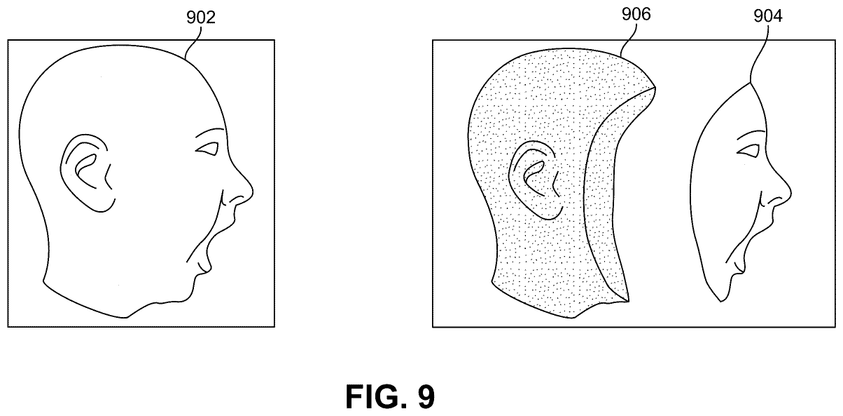

Generating a 3DMM mesh based on 3DMM coefficients as applied to frozen basis vectors may be a linear function and this may limit the amount of detail that can be provided. In some cases, it may be useful to allow the basis vector values to change (e.g., unfreeze) and use a non-linear function, allowing the function and/or basis vector values to change from person to person to allow for a more detailed 3DMM. Additionally, certain portions of a face typically are more dynamic than other portions of the face. FIG. 9 illustrates a parameterized inner mesh model in accordance with aspects of the present disclosure. In FIG. 9 a typical 3DMM 902 is shown. In a typical 3DMM 902, an entire face may be parameterized and estimated (as used herein, a face may refer to human head, including representations of eyes, nose, mouth, ears, a back of the head, etc., without hair) by a ML model (e.g., encoder 712, 732 of FIG. 7). However, typically for humans, an inner portion of a face 904 (e.g., a portion of the face including a forehead, eyes, nose, mouth and portion of a chin) changes based on an expression, while an outer portion of the face 906 is static or rarely changes. In some cases, it may be useful to allow the parameters predicted by an encoder to be used to describe the more dynamic inner portions of the face 904 and the outer portion of the face 906 may be static. In some cases, an encoder trained to predict a mesh for the inner portions of the face 904 and fuse the mesh for the inner portions of the face 904 with a static mesh outer portion of the face may be used in place of an encoder for generating 3DMM coefficients, such as encoders 712 and 732 of FIG. 7 and 3DMM decoder 716 and 738. In some cases, a number of learnable parameters of a neural network, which depends on a number of input vertices, used for reconstruction of the inner portions of the face 904 may be less that the number of vertices used for reconstruction of an entire face, such as in a typical 3DMM 902.

In some cases, a ground truth mesh, such as ground truth mesh 720 may be divided into an inner portion of the face 904 and outer portion of the face 906. In some cases, this division between the inner portion of the face 904 and inner portion of the face 904 may be based on an identified set of vertices as the vertices for a 3DMM model may correspond to known locations on a face. In some cases, from frame to frame, while the static outer portion of the face 906 does not change with an expression, the mesh may have movements due to, for example, tracking errors, which may not be reflected in captured HMD images. In some cases, the per-frame ground truth mesh may be pre-processed. In some cases, pre-processing the ground truth mesh may help ensure that a region that is not affected by the expression changes (e.g., outer portion of the face 906) should be static and thus does not need not to be estimated, that a region of the mesh not visible in HMD images but is affected by the mesh under the should have a consistent correlation with the visible parts, and the region of the mesh that is predicted (e.g., inner portion of the face 904) can be joined with the static region without have to perform complex blending operations.

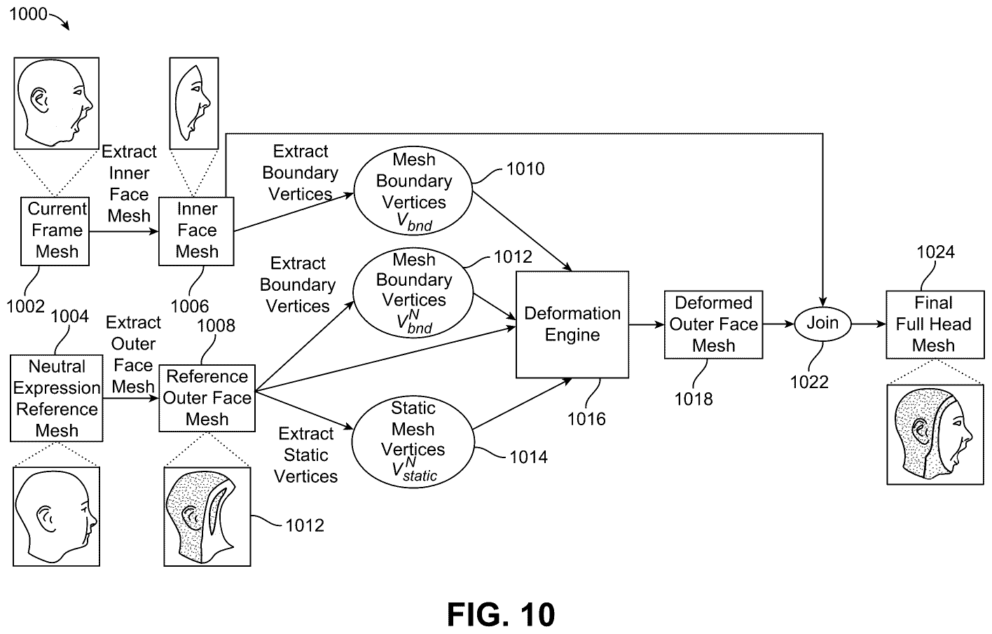

FIG. 10 is a diagram illustrating a technique for pre-processing 3DMM meshes 1000, in accordance with aspects of the present disclosure. In some cases, a 3DMM mesh, such as a ground truth mesh, may be pre-processed to ensure that the static portion (e.g., outer portion) of the face does not change. In FIG. 10, a current frame mesh 1002 (e.g., a frame for generating a ground truth mesh) being processed may be received along with a reference mesh 1004 with a neural expression. In some cases, the current frame mesh 1002 (e.g., training mesh) may include one or more expressions, such as a 3DMM for use as a ground truth reference including an expression for training. The reference mesh 1004 may be a personalized 3DMM for a user having a neutral expression. In some cases, the inner face mesh 1006 may be extracted from the current frame mesh 1002 (e.g., training mesh). The outer face mesh may be extracted from the neutral expression reference mesh as the reference outer face mesh 1008. For example, a 3DMM may have vertices with a known reference position on a face. These vertices may be moved (relative to the 3DMM) to adjust a shape of the 3DMM to match an associated the reference position on the face based on a shape of the face and/or expression being emoted. In some cases, certain vertices may be associated with the inner face and other vertices may be associated with the outer face. The inner face and outer face may then be extracted from a 3DMM based on the association.

Inner mesh boundary vertices (V_{bnd}) 1010 (e.g., vertices on the edge) of the inner face mesh 1006 may be extracted (e.g., located, identified, etc.). Similarly, outer mesh boundary vertices

$$( {V}_{bnd}^{N} )$$

1012 of the outer face mesh 1008 may be extracted. In some cases, the outer mesh boundary vertices

$$( {V}_{bnd}^{N} )$$

1012 and/or inner mesh boundary vertices (V_{bnd}) 1010 may include vertices within a certain distance (e.g., number of nodes) of an edge of the outer face region and/or inner face region. Static mesh vertices

$$( {V}_{static}^{N} )$$

1014 (e.g., vertices of the reference outer mesh 1008) may also be extracted. The static mesh vertices

$$( {V}_{static}^{N} )$$

1014 may be vertices of the outer face portion that are expected to remain static.

The extracted inner mesh boundary vertices (V_{bnd}) 1010, extracted outer mesh boundaries

$$( {V}_{bnd}^{N} )$$

1012, and extracted static mesh vertices

$$( {V}_{static}^{N} )$$

1014 may be passed to a deformation engine 1016. The reference outer face mesh 1008 may also be passed to the deformation engine 1016. The deformation engine 1016 may deform the reference outer face mesh 1008 (e.g., the outer mesh boundary vertices) to fit the extracted inner mesh boundary vertices 1010, generating the deformed outer face mesh 1018. For example, the deformation engine 106 may deform the reference outer face mesh 1008 by minimizing

$$‖ {V}_{bnd} - {V}_{bnd}^{N} ‖ ,$$

minimizing changes in the static mesh vertices

$$( Δ {V}_{static}^{N} ) ,$$

and minimizing changes in Laplacian coordinates of the reference outer mesh 1008.

The deformed outer face mesh 1018 may be joined 1022 (e.g., add, fuse, etc.) to the inner face mesh 1006 to generate a final full head mesh 1024. In some cases, the deformed outer face mesh 1018 may be joined 1022 to the inner face mesh 1006 using Laplacian mesh editing to blend the outer mesh boundary vertices 1010 and inner face mesh 1006. For example, the Laplacian mesh editing may deform the mesh to minimize distances between positions of pre-defined anchor vertices and their new assigned locations, minimize distance between positions of pre-defined static vertices before and after deformation, and preserver local geometry. A mesh in Laplacian coordinates may be represented as

$${δ}_{i} = \frac{{\sum }_{j ∈ N ( i )} {W}_{ij} ( {V}_{j} - {V}_{i} )}{{\sum }_{j ∈ N ( i )} {W}_{ij}} ;$$

Wᵢⱼ=cot αᵢⱼ+cot βᵢⱼ, where δᵢ represents Laplacian Coordinates of vertex i, N(i) represents neighbors of vertex i, and Wᵢⱼ represents weight of vertex j. A matrix representation may be expressed as [L][V]=[δ]; [V]—matrix of n×3, [δ]—matrix of n×3, [L]—matrix of n×n. The optimization may be expressed as

$$\check{X} = {arg min}_{X} {‖ LX - δ ‖}^{2} + {\sum }_{S = 1 … K} {\vert {X}_{S} - {C}_{S} \vert}^{2} ,$$

where S represents a list of static and anchor vertices, C_{S} represents new position anchor and existing position of static vertices.

As indicated above, an encoder may be trained to predict parameters (e.g., 3DMM coefficients) for describing an inner face region of a face based on images from an HMD. FIG. 11 is a block diagram illustrating a technique for training 1100 a ML model for predicting parameters for describing an inner face region of a face based on images from an HMD, in accordance with aspects of the present disclosure. In some cases, an ML model trained using the technique for training 1100 may be used in conjunction with the technique for training a ML model 700 to perform mesh estimation using HMD images, for example, by substituting the technique for training 1100 in place of encoder 712, 3DMM coefficients 714, and 3DMM decoder 716.

In some cases, an encoder-decoder ML model architecture may be used for predicting parameters for describing an inner face region based on images from an HMD. In some cases, the technique for training 1100 may include a first phase 1120 and a second phase 1122. In some cases, the first phase 1120 may be variational autoencoder (VAE) based as an input mesh 1102 (e.g., ground truth inner face mesh mesh) (S_{GT}) may be input to encoder 1104 (e.g., training encoder) to generate an embedding 1106 z_{ϕ}_{₁}, which may then be passed to a decoder 1108 to output a predicted mesh 1110 (S_{ϕ}_{₁}). One or more losses 1124 between the predicted mesh 1110 S_{ϕ}_{₁} and the input mesh 1102 S_{GT} may be determined and used to adjust weights in the encoder 1104 and/or decoder 1108 to minimize information loss between the input mesh 1102 S_{GT} and the predicted mesh 1110. The encoder 1104 may compress the input mesh 1102 to a latent space representation (e.g., embedding 1106 z_{ϕ}_{₁}) capturing the geometry information of the input mesh 1102. The decoder 1108 may decompress the embedding 1106 z_{ϕ}_{₁} back to the mesh space as the predicted mesh 1110 S_{ϕ}_{₁}. In some cases, the losses 1124 may include a landmark loss ( [symbol] _{lmk P2P}) representing a mean square error (MSE) loss for landmark vertices positions between estimated and GT meshes (e.g.,

$${ℒ}_{lmk P 2 P} = {‖ lmk ( {S}_{GT} - {S}_{{ϕ}_{1}} ) ‖}_{2} ,$$

where lmk(S) will give landmark vertices for mesh S), a vertex loss ( [symbol] _{vtx P2P}) representing an MSE loss on all inner face vertices positions between estimated and GT meshes (e.g.,

$${ℒ}_{vtx P 2 P} = {‖ {S}_{GT} - {S}_{{ϕ}_{1}} ‖}_{2} ,$$

where [symbol] ₗₐₚ represents a Laplacian smoothing loss), a point to point loss ( [symbol] _{P2S}) representing a point to point loss on inner face vertices (e.g., all inner face vertices) projected along the surface normals of the meshes, and/or a KL Divergence loss ( [symbol] _{KL}) between z_{ϕ}_{₁} and N(0, I).

In some cases, the input mesh 1102 S_{GT} may include normalized vertex offsets for the inner face of the current frame with respect to the static neutral mesh. In some cases, the static neural mesh may be a per person static neural mesh. Of note, the offsets may capture the expression information. In some cases, normalization may be performed by computing σᵢ of positions for vertex Vᵢ and dividing the position of the vertex Vᵢ for the current frame by 2*σᵢ. In some cases, division by higher sigma ensures that small movements due to noisy ground truth meshes can be ignored by the reconstruction losses.

In the second phase 1122, HMD images 1112 (e.g., corresponding to the input mesh 1102 S_{GT}) may be passed into an encoder 1114. The encoder 1114 may learn to predict the embedding 1106 z_{ϕ}_{₁} based on the HMD images 1112. For example, the encoder 1114 may estimate an embedding 1116 z_{ϕ}_{₂}. The estimated embedding 1116 z_{ϕ}_{₂} should be such that when decoded using the decoder 1108 (e.g., decoder 1108 trained in Phase 1 1120), the decoder 1108 should reconstruct the predicted mesh 1110 S_{ϕ}_{₁}. In some cases, one or more losses 1118 may be determined as between the embedding 1106 z_{ϕ}_{₁} and embedding 1116 z_{ϕ}_{₂}. In some cases, the encoder 1114 may learn to estimate z_{ϕ}_{₁}−z̅_{ϕ}_{₁} which is the offset of z_{ϕ}_{₁} (corresponding to current frame) from the mean embedding z_{ϕ}_{₁} for a user (e.g., personalized mesh). For example, the one or more losses 1118 may include a robust loss

$$ρ ( {ℒ}_{MSE}^{Δ} ) , where {ℒ}_{MSE}^{Δ}$$

represents a MSE between z_{ϕ}_{₂} & (z_{ϕ}_{₁}−z̅_{ϕ}_{₁}), and ρ(x) applies robust function on x. In some cases, the robust function may be expressed as

$$p ( x \vert μ , α , c ) = \frac{1}{cZ ( α )} exp ( - ρ ( x - μ , α , c ) ) , \\ ρ ( x , α , c ) = \{ \begin{matrix}\frac{1}{2} {( \frac{x}{c} )}^{2} , & α = 2 \\ log ( \frac{1}{2} {( \frac{x}{c} )}^{2} + 1 ) , & α = 0 \\ 1 - exp ( \frac{1}{2} {( \frac{x}{c} )}^{2} ) , & α = - ∞ \\ \frac{\vert α - 2 \vert}{α} ( {( \frac{{( \frac{x}{c} )}^{2}}{\vert α - 2 \vert} + 1 )}^{\frac{α}{2}} - 1 ) , & otherwise\end{matrix}$$

α represents a same dimension vector as μ and controlling a shape of loss at the origin and where β represents a same dimension as vector and controlling a scale of each dimension in the loss. In some cases, the Negative Log Likelihood (NLL) of the robust probability density function may be maximized during the entire training dataset by optimizing x, α and β.

One or more losses 1126 between the predicted mesh 1110 S_{ϕ}_{₂} from the second stage and the predicted mesh 1110 S_{ϕ}_{₁} from the first stage may be determined and used to adjust weights in the encoder 1114 (and in some cases the encoder 1104) and/or decoder 1108 to minimize information loss between the predicted mesh 1110 S_{ϕ2} and the predicted mesh 1110 S_{ϕ}_{₁}. In some cases, the one or more losses 1126 may include a landmark loss ( [symbol] _{lmk P2P}) representing a MSE loss for landmark vertices positions between estimated meshes (e.g.,

$${ℒ}_{lmk P 2 P} = {‖ lmk ( {S}_{{ϕ}_{2}} - {S}_{{ϕ}_{1}} ) ‖}_{2} ,$$

where lmk(S) will give landmark vertices for mesh S) and/or a point to point loss ( [symbol] _{P2S}) representing a point to point loss on inner face vertices (e.g., all inner face vertices) projected along the surface normals of the meshes.

In some cases, an expression may be transferred across users. For example, a mean (e.g., mean inner face) for all of the training dataset embeddings for individual IDs Z̅_̅{̅i̅d̅}̅ may be determined. A current frame embedding for a user with a mean of corresponding ID (e.g. id1) may be represented as a difference between the frame embedding for the user and the mean embedding as Z−Z̅_̅{̅i̅d̅1̅}̅. A difference to the mean of target ID (e.g. id2) may be added and then the embeddings may be decoded, such that Decode (Z̅_̅{̅i̅d̅2̅}̅+Z−Z̅_̅{̅i̅d̅1̅}̅).

In some cases, inference operates in a manner similar to the second phase 1122. For example, HMD images 1112 may be passed into the encoder 1114 and the encoder 1114 may predict a set of parameters (e.g., coefficients) which describe the inner face of a user. In some cases, the set of parameters describing the inner face of the user may have fewer parameters as compared to a set of parameters that may be used for a full face. The decoder 1108 may then decode the set of parameters to predict a mesh for the inner face (e.g., inner face mesh). An outer face mesh for the user may be obtained (e.g., retrieved from memory). The inner face mesh and outer face mesh may be joined in a manner similar to that described in FIG. 10. The inner face mesh may be used as inner face mesh 1006, and the outer face mesh may be used as the outer face mesh 1008.

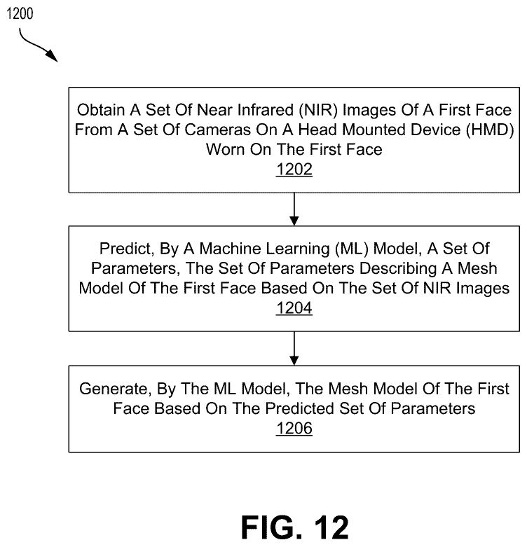

FIG. 12 is a flow diagram illustrating a process 1200 for generating a mesh model, in accordance with aspects of the present disclosure. The process 1200 may be performed by a computing device (or apparatus) or a component (e.g., a chipset, codec, etc.) of the computing device, such as host processor 152 of FIG. 1, compute components 210 of FIG. 2, and/or processor 1510 of FIG. 15. The computing device may be a mobile device (e.g., a mobile phone, mobile device), a network-connected wearable such as a watch, an extended reality (XR) device such as a virtual reality (VR) device or augmented reality (AR) device (e.g., HMD 510 of FIGS. 5A and 5B), a companion device, vehicle or component or system of a vehicle, or other type of computing device. The operations of the process 1200 may be implemented as software components that are executed and run on one or more processors (e.g., host processor 152 of FIG. 1, compute components 210 of FIG. 2, and/or processor 1510 of FIG. 15).

At block 1202, the computing device (or component thereof) can obtain a set of near infrared (NIR) images of a first face from a set of cameras on a head mounted device (HMD) worn on the first face.

At block 1204, the computing device (or component thereof) can predict, using a machine learning (ML) model, a set of parameters, the set of parameters describing a mesh model of the first face based on the set of NIR images. In some cases, the ML model can include an encoder for generating a set of coefficients indicating deformations for the mesh model and a decoder for predicting the mesh model based on the set of coefficients. In some aspects, the computing device (or component thereof) can apply a temporal filter to the predicted training mesh model and/or to parameters describing the predicted training mesh model to generate a pseudo-ground truth mesh. The computing device (or component thereof) can estimate a smoothened predicted training mesh model based on a real NIR HMD user image. The computing device (or component thereof) can compare the smoothened predicted training mesh model and the pseudo-ground truth mesh to train the ML model.

In some aspects, as described herein, the ML model can be trained by generating a synthetic HMD user image based on a training mesh model (e.g., a synthetic HMD user image of a textured ground truth mesh). In some examples, the synthetic HMD user image is generated based on a reference location of a camera in the first reference mesh model. In some cases, the training mesh model can be generated by aligning a first reference mesh model of a reference HMD to a second reference mesh model of the reference face. In some examples, aligning the first reference mesh model of the reference HMD to the second reference mesh model of the reference face includes aligning the first reference mesh model based on vertices of the second reference mesh model. The ML model can be trained further by converting the synthetic HMD user image to a synthetic NIR HMD user image. In some aspects, the synthetic HMD user image can be converted to a synthetic NIR HMD user image using a ML model trained to convert color images to a synthetic NTR image. The ML model can be trained further by estimating, by the ML model, a predicted training mesh model of a reference face based on the synthetic NIR HMD user image and comparing the predicted training mesh model to the training mesh model to train the ML model. In some aspects, one or more augmentations to the synthetic HMD user image. In some aspects, the one or more augmentations include a color augmentation, affine transformation, noise injection, any combination thereof, and/or other augmentation(s).

At block 1206, the computing device (or component thereof) can generate, using the ML model, the mesh model of the first face based on the predicted set of parameters.

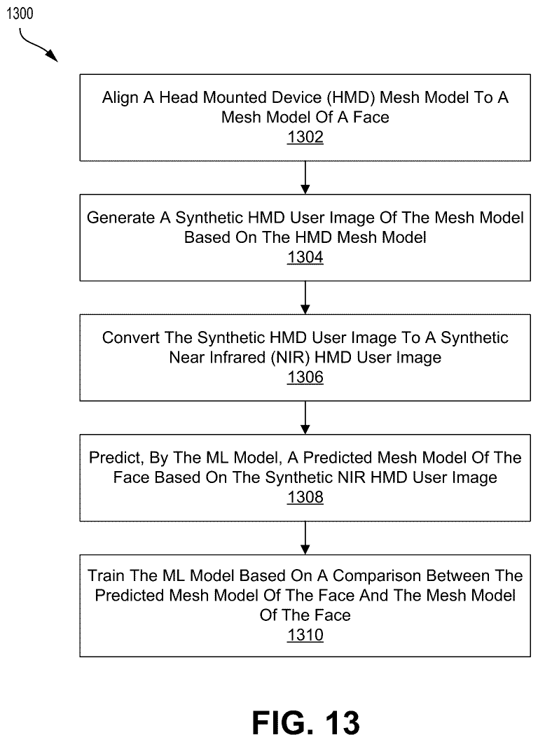

FIG. 13 is a flow diagram illustrating a process 1300 for training an ML model, in accordance with aspects of the present disclosure. The process 1300 may be performed by a computing device (or apparatus) or a component (e.g., a chipset, codec, etc.) of the computing device, such as host processor 152 of FIG. 1, compute components 210 of FIG. 2, and/or processor 1510 of FIG. 15. The computing device may be a mobile device (e.g., a mobile phone, mobile device), a network-connected wearable such as a watch, an extended reality (XR) device such as a virtual reality (VR) device or augmented reality (AR) device (e.g., HMD 510 of FIGS. 5A and 5B), a companion device, vehicle or component or system of a vehicle, or other type of computing device. The operations of the process 1300 may be implemented as software components that are executed and run on one or more processors (e.g., host processor 152 of FIG. 1, compute components 210 of FIG. 2, and/or processor 1510 of FIG. 15).

At block 1302, the computing device (or component thereof) can align a head mounted device (HMD) mesh model (e.g., a training mesh model) to a mesh model of a face. In some examples, aligning the HMD mesh model to the mesh model of the face includes aligning the HMD mesh model based on vertices of the mesh model of the face.

At block 1304, the computing device (or component thereof) can generate a synthetic HMD user image of the mesh model based on the HMD mesh model. In some examples, the synthetic HMD user image is generated based on a reference location of a camera in the HMD mesh model.

At block 1306, the computing device (or component thereof) can convert the synthetic HMD user image to a synthetic near infrared (NIR) HMD user image. In some aspects, the synthetic HMD user image can be converted to the synthetic NIR HMD user image using a ML model trained to convert color images to a synthetic NIR image. In some cases, one or more augmentations to the synthetic HMD user image (e.g., prior to converting to the synthetic NIR HMD user image. In some aspects, the one or more augmentations include a color augmentation, affine transformation, noise injection, any combination thereof, and/or other augmentation(s).

At block 1308, the computing device (or component thereof) can predict, by the ML model, a predicted mesh model of the face (e.g., a predicted training mesh model of a reference face) based on the synthetic NIR HMD user image.

At block 1310, the computing device (or component thereof) can train the ML model based on a comparison between the predicted mesh model of the face and the mesh model of the face.

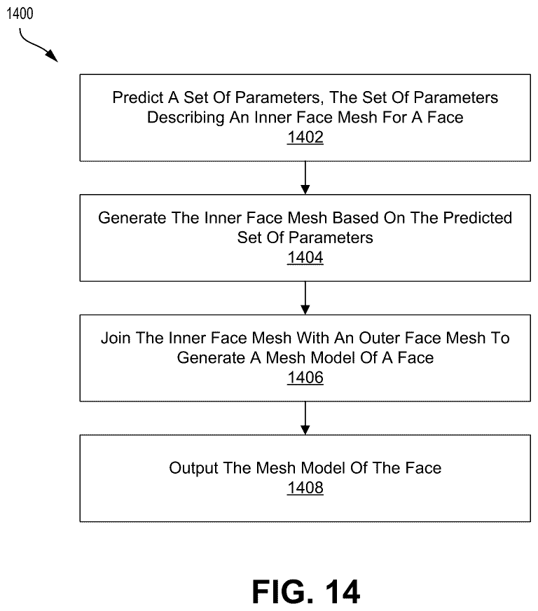

FIG. 14 is a flow diagram illustrating a process 1400 for generating a mesh model, in accordance with aspects of the present disclosure. The process 1400 may be performed by a computing device (or apparatus) or a component (e.g., a chipset, codec, etc.) of the computing device, such as host processor 152 of FIG. 1, compute components 210 of FIG. 2, and/or processor 1510 of FIG. 15. The computing device may be a mobile device (e.g., a mobile phone, mobile device), a network-connected wearable such as a watch, an extended reality (XR) device such as a virtual reality (VR) device or augmented reality (AR) device (e.g., HMD 510 of FIGS. 5A and 5B), a companion device, vehicle or component or system of a vehicle, or other type of computing device. The operations of the process 1400 may be implemented as software components that are executed and run on one or more processors (e.g., host processor 152 of FIG. 1, compute components 210 of FIG. 2, and/or processor 1510 of FIG. 15).

At block 1402, the computing device (or component thereof) can predict a set of parameters, the set of parameters describing an inner face mesh for a face. In some cases, the inner face mesh can include a representation of a forehead, eyes, nose, mouth and portion of a chin of a person. In some cases, the outer face mesh includes a representation of ears, back of a head, and top of a head of the person. In some aspects, the computing device (or component thereof) can predict the set of parameters using an encoder and generate the inner face mesh using a decoder. In some cases, the encoder and decoder are trained based on a ground truth face mesh. For instance, in some examples, the ground truth face mesh can be generated by extracting a reference outer face mesh from a neutral expression reference mesh, deforming the reference outer face mesh based on an extracted inner face mesh, and joining the deformed reference outer face mesh and extracted inner face mesh to form the ground truth face mesh.

In some cases, the decoder is trained based on a training encoder. In such cases, the decoder can be trained by generating, by the training encoder, a first embedding based on an input inner face mesh, generating, by the decoder, a predicted inner face mesh, and training the decoder based on a comparison between the input inner face mesh and the predicted inner face mesh. In some aspects, the encoder can be trained by generating, by the encoder, a second embedding based on a synthetic NIR HMD user image corresponding to the inner face mesh and training the encoder based on a comparison between the second embedding and the first embedding. In some examples, the computing device (or component thereof) can generate, using the encoder, a third embedding based on NIR HMD user images, where the third embedding represents an expression of a first face. In some cases, the third embedding is represented by a difference between an embedding of the first face an embedding of a mean face. In some cases, the computing device (or component thereof) can add a difference between a second embedding to the difference between the embedding of first face and the embedding of the mean face to transfer the expression represented by the third embedding to a second face.

At block 1404, the computing device (or component thereof) can generate the inner face mesh based on the predicted set of parameters.

At block 1406, the computing device (or component thereof) can join the inner face mesh with an outer face mesh to generate a mesh model of a face. In some aspects, to join the inner face mesh with the outer face mesh, the computing device (or component thereof) can extract first mesh boundary vertices of the inner face mesh, extract second mesh boundary vertices of the outer face mesh, deform the second mesh boundary vertices based on the first mesh boundary vertices, and join the inner face mesh and the outer face mesh. In some cases, the computing device (or component thereof) can extract static vertices of the outer face mesh. In such cases, to deform the second mesh boundary vertices based on the first mesh boundary vertices, the computing device (or component thereof) can deform the second mesh boundary vertices to fit the first mesh boundary vertices while minimizing distances between positions of a set of vertices of the static vertices.

At block 1408, the computing device (or component thereof) can output the mesh model of the face.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1200, process 1300, process 1400 and/or other processes described herein may include a processor, microprocessor, micro-computer, or other component of a device that is configured to carry out the steps of the process 1200, process 1300, process 1400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1200, process 1300, process 1400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

Process 1200, process 1300, and process 1400 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1200, process 1300, process 1400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some examples, computing system 1500 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1500 includes at least one processing unit (CPU or processor) 1510 and connection 1505 that couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, camera, accelerometers, gyroscopes, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some examples, a hardware service that performs a particular function can include the software component stored in a computer-readable medium in connection with the necessary hardware components, such as processor 1510, connection 1505, output device 1535, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for generating one or more mesh models, the apparatus comprising: at least one memory; and at least one processor coupled to the at least one memory and configured to: obtain a set of near infrared (NIR) images of a first face from a set of cameras on a head mounted device (HMD) worn on the first face; predict, using a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and generate, using the ML model, the mesh model of the first face based on the predicted set of parameters.

Aspect 2. The apparatus of Aspect 1, wherein the training mesh model is generated by aligning a first reference mesh model of a reference HMD to a second reference mesh model of the reference face.

Aspect 3. The apparatus of Aspect 2, wherein the synthetic HMD user image is generated based on a reference location of a camera in the first reference mesh model.

Aspect 4. The apparatus of any of Aspects 2 or 3, wherein aligning the first reference mesh model of the reference HMD to the second reference mesh model of the reference face comprises aligning the first reference mesh model based on vertices of the second reference mesh model.

Aspect 5. The apparatus of any of Aspects 1 to 4, wherein the at least one processor is configured to apply one or more augmentations to the synthetic HMD user image.

Aspect 6. The apparatus of Aspect 5, wherein the one or more augmentations comprise at least one of a color augmentation, affine transformation, or noise injection.

Aspect 7. The apparatus of any of Aspects 1 to 6, wherein the ML model includes: an encoder for generating a set of coefficients indicating deformations for the mesh model; and a decoder for predicting the mesh model based on the set of coefficients.

Aspect 8. The apparatus of any of Aspects 1 to 7, wherein the at least one processor is configured to: apply a temporal filter to at least one of the predicted training mesh model or parameters describing the predicted training mesh model to generate a pseudo-ground truth mesh; estimate a smoothened predicted training mesh model based on a real NIR HMD user image; and compare the smoothened predicted training mesh model and the pseudo-ground truth mesh to train the ML model.

Aspect 9. The apparatus of any of Aspects 1 to 8, wherein converting the synthetic HMD user image to a synthetic NIR MID user image comprises a ML model trained to convert color images to a synthetic NIR image.

Aspect 10. An apparatus for generating a mesh model, the apparatus comprising: at least one memory; and at least one processor coupled to the at least one memory and configured to: predict a set of parameters, the set of parameters describing an inner face mesh for a face; generate the inner face mesh based on the predicted set of parameters; join the inner face mesh with an outer face mesh to generate a mesh model of a face; and output the mesh model of the face.

Aspect 11. The apparatus of Aspect 10, wherein the inner face mesh includes a representation of a forehead, eyes, nose, mouth and portion of a chin of a person, and wherein the outer face mesh includes a representation of ears, back of a head, and top of a head of the person.

Aspect 12. The apparatus of any of Aspects 10 or 11, wherein, to join the inner face mesh with the outer face mesh, the at least one processor is configured to: extract first mesh boundary vertices of the inner face mesh; extract second mesh boundary vertices of the outer face mesh; deform the second mesh boundary vertices based on the first mesh boundary vertices; and join the inner face mesh and the outer face mesh.

Aspect 13. The apparatus of Aspect 12, wherein the at least one processor is configured to extract static vertices of the outer face mesh, and wherein, to deform the second mesh boundary vertices based on the first mesh boundary vertices, the at least one processor is configured to deform the second mesh boundary vertices to fit the first mesh boundary vertices while minimizing distances between positions of a set of vertices of the static vertices.

Aspect 14. The apparatus of any of Aspects 10 to 13, wherein the at least one processor is configured to predict the set of parameters using an encoder and generate the inner face mesh using a decoder.

Aspect 15. The apparatus of Aspect 14, wherein the encoder and decoder are trained based on a ground truth face mesh.

Aspect 16. The apparatus of Aspect 15, wherein the ground truth face mesh is generated by: extracting a reference outer face mesh from a neutral expression reference mesh; deforming the reference outer face mesh based on an extracted inner face mesh; and joining the deformed reference outer face mesh and extracted inner face mesh to form the ground truth face mesh.

Aspect 17. The apparatus of any of Aspects 14 to 16, wherein the decoder is trained based on a training encoder, and wherein the decoder is trained by: generating, by the training encoder, a first embedding based on an input inner face mesh; generating, by the decoder, a predicted inner face mesh; and training the decoder based on a comparison between the input inner face mesh and the predicted inner face mesh.

Aspect 18. The apparatus of Aspect 17, wherein the encoder is trained by: generating, by the encoder, a second embedding based on a synthetic NIR HMD user image corresponding to the inner face mesh; and training the encoder based on a comparison between the second embedding and the first embedding.

Aspect 19. The apparatus of any of Aspects 14 to 18, wherein the at least one processor is configured to generate, using the encoder, a third embedding based on NIR HMD user images, wherein the third embedding represents an expression of a first face.

Aspect 20. The apparatus of Aspect 19, wherein the third embedding is represented by a difference between an embedding of the first face an embedding of a mean face.

Aspect 21. The apparatus of Aspect 20, wherein the at least one processor is configured to add a difference between a second embedding to the difference between the embedding of first face and the embedding of the mean face to transfer the expression represented by the third embedding to a second face.

Aspect 22. A method for generating one or more mesh models, comprising: obtaining a set of near infrared (NIR) images of a first face from a set of cameras on a head mounted device (HMD) worn on the first face; predicting, by a machine learning (ML) model, a set of parameters, the set of parameters describing a mesh model of the first face based on the set of NIR images, wherein the ML model is trained by: generating a synthetic HMD user image based on a training mesh model; converting the synthetic HMD user image to a synthetic NIR HMD user image; estimating, by the ML model, a predicted training mesh model of a reference face based on the synthetic NIR HMD user image; and comparing the predicted training mesh model to the training mesh model to train the ML model; and generating, by the ML model, the mesh model of the first face based on the predicted set of parameters.

Aspect 23. The method of Aspect 22, wherein the training mesh model is generated by aligning a first reference mesh model of a reference HMD to a second reference mesh model of the reference face.

Aspect 24. The method of Aspect 23, wherein the synthetic HMD user image is generated based on a reference location of a camera in the first reference mesh model.

Aspect 25. The method of any of Aspects 23 or 24, wherein aligning the first reference mesh model of the reference HMD to the second reference mesh model of the reference face comprises aligning the first reference mesh model based on vertices of the second reference mesh model.

Aspect 26. The method of any of Aspects 22 to 25, further comprising applying one or more augmentations to the synthetic HMD user image.

Aspect 27. The method of Aspect 26, wherein the one or more augmentations comprise at least one of a color augmentation, affine transformation, or noise injection.

Aspect 28. The method of any of Aspects 22 to 27, wherein the ML model includes: an encoder for generating a set of coefficients indicating deformations for the mesh model; and a decoder for predicting the mesh model based on the set of coefficients.

Aspect 29. The method of any of Aspects 22 to 28, further comprising: applying a temporal filter to at least one of the predicted training mesh model or parameters describing the predicted training mesh model to generate a pseudo-ground truth mesh; estimating a smoothened predicted training mesh model based on a real NIR HMD user image; and comparing the smoothened predicted training mesh model and the pseudo-ground truth mesh to train the ML model.

Aspect 30. The method of any of Aspects 22 to 29, wherein converting the synthetic HMD user image to a synthetic NIR MID user image comprises a ML model trained to convert color images to a synthetic NIR image.

Aspect 31. A method for generating a mesh model, comprising: predicting a set of parameters, the set of parameters describing an inner face mesh for a face; generating the inner face mesh based on the predicted set of parameters; joining the inner face mesh with an outer face mesh to generate a mesh model of a face; and outputting the mesh model of the face.

Aspect 32. The method of Aspect 31, wherein the inner face mesh includes a representation of a forehead, eyes, nose, mouth and portion of a chin of a person, and wherein the outer face mesh includes a representation of ears, back of a head, and top of a head of the person.

Aspect 33. The method of any of Aspects 31 or 32, wherein joining the inner face mesh with the outer face mesh comprises: extracting first mesh boundary vertices of the inner face mesh; extracting second mesh boundary vertices of the outer face mesh; deforming the second mesh boundary vertices based on the first mesh boundary vertices; and joining the inner face mesh and the outer face mesh.

Aspect 34. The method of Aspect 33, further comprising extracting static vertices of the outer face mesh, wherein deforming the second mesh boundary vertices based on the first mesh boundary vertices comprises deforming the second mesh boundary vertices to fit the first mesh boundary vertices while minimizing distances between positions of a set of vertices of the static vertices.

Aspect 35. The method of any of Aspects 31 to 34, wherein the set of parameters are predicted by an encoder and wherein the inner face mesh is generated by a decoder.

Aspect 36. The method of Aspect 35, wherein the encoder and decoder are trained based on a ground truth face mesh.

Aspect 37. The method of Aspect 36, wherein the ground truth face mesh is generated by: extracting a reference outer face mesh from a neutral expression reference mesh; deforming the reference outer face mesh based on an extracted inner face mesh; and joining the deformed reference outer face mesh and extracted inner face mesh to form the ground truth face mesh.

Aspect 38. The method of any of Aspects 35 to 37, wherein the decoder is trained based on a training encoder, and wherein the decoder is trained by: generating, by the training encoder, a first embedding based on an input inner face mesh; generating, by the decoder, a predicted inner face mesh; and training the decoder based on a comparison between the input inner face mesh and the predicted inner face mesh.

Aspect 39. The method of Aspect 38, wherein the encoder is trained by: generating, by the encoder, a second embedding based on a synthetic NIR HMD user image corresponding to the inner face mesh; and training the encoder based on a comparison between the second embedding and the first embedding.

Aspect 40. The method of any of Aspects 35 to 39, further comprising generating, by the encoder, a third embedding based on NIR HMD user images, wherein the third embedding represents an expression of a first face.

Aspect 41. The method of Aspect 40, wherein the third embedding is represented by a difference between an embedding of the first face an embedding of a mean face.

Aspect 42. The method of Aspect 41, further comprising adding a difference between a second embedding to the difference between the embedding of first face and the embedding of the mean face to transfer the expression represented by the third embedding to a second face.

Aspect 43. A non-transitory computer-readable medium having stored thereon instructions that, when executed by at least one processor, cause the at least one processor to perform operations according to any of Aspects 22-30.

Aspect 44. An apparatus for generating one or more mesh models, comprising one or more means for performing operations according to any of Aspects 22-30.

Aspect 45. A non-transitory computer-readable medium having stored thereon instructions that, when executed by at least one processor, cause the at least one processor to perform operations according to any of Aspects 31-42.

Aspect 46. An apparatus for generating one or more mesh models, comprising one or more means for performing operations according to any of Aspects 31-42.

What is claimed is:

1. An apparatus for generating one or more mesh models, the apparatus comprising:
at least one memory; and
at least one processor coupled to the at least one memory and configured to:
obtain a set of near infrared (NIR) images of a first face from a set of cameras on a head mounted device (HMD) worn on the first face;
predict, using a machine learning (ML) model, a set of parameters, the set of parameters describing a mesh model of the first face based on the set of NIR images, wherein the ML model is trained by:
generating a synthetic HMD user image based on a training mesh model;
converting the synthetic HMD user image to a synthetic NIR HMD user image;
estimating, by the ML model, a predicted training mesh model of a reference face based on the synthetic NIR HMD user image; and
comparing the predicted training mesh model to the training mesh model to train the ML model; and
generate, using the ML model, the mesh model of the first face based on the predicted set of parameters.

2. The apparatus of claim 1, wherein the training mesh model is generated by aligning a first reference mesh model of a reference HMD to a second reference mesh model of the reference face.

3. The apparatus of claim 2, wherein the synthetic HMD user image is generated based on a reference location of a camera in the first reference mesh model.

4. The apparatus of claim 2, wherein aligning the first reference mesh model of the reference HMD to the second reference mesh model of the reference face comprises aligning the first reference mesh model based on vertices of the second reference mesh model.

5. The apparatus of claim 1, wherein the at least one processor is configured to apply one or more augmentations to the synthetic HMD user image.

6. The apparatus of claim 5, wherein the one or more augmentations comprise at least one of a color augmentation, affine transformation, or noise injection.

7. The apparatus of claim 1, wherein the ML model includes:
an encoder for generating a set of coefficients indicating deformations for the mesh model; and
a decoder for predicting the mesh model based on the set of coefficients.

8. The apparatus of claim 1, wherein the at least one processor is configured to:
apply a temporal filter to at least one of the predicted training mesh model or parameters describing the predicted training mesh model to generate a pseudo-ground truth mesh;
estimate a smoothened predicted training mesh model based on a real NIR HMD user image; and
compare the smoothened predicted training mesh model and the pseudo-ground truth mesh to train the ML model.

9. The apparatus of claim 1, wherein converting the synthetic HMD user image to a synthetic NIR HMD user image comprises a ML model trained to convert color images to a synthetic NIR image.

10. An apparatus for generating a mesh model, the apparatus comprising:
at least one memory; and
at least one processor coupled to the at least one memory and configured to:
predict a set of parameters, the set of parameters describing an inner face mesh for a face;
generate the inner face mesh based on the predicted set of parameters;
join the inner face mesh with an outer face mesh to generate a mesh model of a face; and
output the mesh model of the face.

11. The apparatus of claim 10, wherein the inner face mesh includes a representation of a forehead, eyes, nose, mouth and portion of a chin of a person, and wherein the outer face mesh includes a representation of ears, back of a head, and top of a head of the person.

12. The apparatus of claim 10, wherein, to join the inner face mesh with the outer face mesh, the at least one processor is configured to:
extract first mesh boundary vertices of the inner face mesh;
extract second mesh boundary vertices of the outer face mesh;
deform the second mesh boundary vertices based on the first mesh boundary vertices; and
join the inner face mesh and the outer face mesh.

13. The apparatus of claim 12, wherein the at least one processor is configured to extract static vertices of the outer face mesh, and wherein, to deform the second mesh boundary vertices based on the first mesh boundary vertices, the at least one processor is configured to deform the second mesh boundary vertices to fit the first mesh boundary vertices while minimizing distances between positions of a set of vertices of the static vertices.

14. The apparatus of claim 10, wherein the at least one processor is configured to predict the set of parameters using an encoder and generate the inner face mesh using a decoder.

15. The apparatus of claim 14, wherein the encoder and decoder are trained based on a ground truth face mesh.

16. The apparatus of claim 15, wherein the ground truth face mesh is generated by:
extracting a reference outer face mesh from a neutral expression reference mesh;
deforming the reference outer face mesh based on an extracted inner face mesh; and
joining the deformed reference outer face mesh and extracted inner face mesh to form the ground truth face mesh.

17. The apparatus of claim 14, wherein the decoder is trained based on a training encoder, and wherein the decoder is trained by:
generating, by the training encoder, a first embedding based on an input inner face mesh;
generating, by the decoder, a predicted inner face mesh; and
training the decoder based on a comparison between the input inner face mesh and the predicted inner face mesh.

18. The apparatus of claim 17, wherein the encoder is trained by:
generating, by the encoder, a second embedding based on a synthetic NIR HMD user image corresponding to the inner face mesh; and
training the encoder based on a comparison between the second embedding and the first embedding.

19. The apparatus of claim 14, wherein the at least one processor is configured to generate, using the encoder, a third embedding based on NIR HMD user images, wherein the third embedding represents an expression of a first face.

20. The apparatus of claim 19, wherein the third embedding is represented by a difference between an embedding of the first face an embedding of a mean face.
